(19) United States
(12) Patent Application Publication
(10) Pub. No.: US 2024/0162715 A1
(43) Pub. Date: May 16, 2024

(54) METHOD FOR GROUP COORDINATED VOLTAGE CONTROL OF PHOTOVOLTAIC INVERTERS IN LOW-VOLTAGE DISTRIBUTION NETWORK

(71) Applicant: Hunan University of Technology, Zhuzhou (CN)

(72) Inventors: Shengqing Li, Zhuzhou (CN); Bowen Liu, Zhuzhou (CN)

(21) Appl. No.: 18/413,140

(22) Filed: Jan. 16, 2024

(51) Int. Cl. H02J 3/38; H02J 3/18

(52) U.S. Cl. CPC H02J 3/381; H02J 3/18; H02J 2203/10; H02J 2203/20; H02J 2300/24

(57) ABSTRACT

The present invention discloses a method for group coordinated voltage control of photovoltaic inverters in a low-voltage distribution network, which relates to the technical field of voltage control of a low-voltage distribution network. The photovoltaic inverters are subjected to group coordinated control, and the sequence of groups for participating in voltage control is adjusted according to the VSF of each group. The photovoltaic inverters in the groups perform voltage control by consistency variables, and coordinated control strategies are used between the groups for control. A group with higher voltage sensitivity is preferably used to participate in voltage control, and then a voltage control instruction is sent to other groups, so as to effectively inhibit voltage overlimit, avoid unnecessary active reduction, and achieve strong robustness during load and photovoltaic fluctuation.

### TECHNICAL FIELD

The present invention relates to the technical field of voltage control of a low-voltage distribution network, and more particularly relates to a method for group coordinated voltage control of photovoltaic inverters in a low-voltage distribution network.

### BACKGROUND

With the increasing aggravation of energy crisis and environmental pollution, the household photovoltaic grid connection in the distribution network has developed rapidly by means of the advantages of cleanness, flexibility and high efficiency. However, massive photovoltaic access has an important influence on the power flow, voltage and network loss of the system, wherein voltage overlimit has become an important factor that limits the massive photovoltaic access. Therefore, for the distribution network with a high photovoltaic proportion, a convenient and effective voltage control strategy is an important basis for the stable operation of a power system.

In recent years, as more and more photovoltaic inverters are connected to the distribution network, many scholars at home and abroad have put forward the idea of DG grouping according to different maximum photovoltaic access amounts and voltage regulation capacities of a Distributed Generation (DG) at different locations of feeders, and have divided the decentralized DG into several groups for regional voltage management. “A decentralized and cooperative architecture for optimal voltage regulation in smart grids” in “IEEE transactions on industrial electronics”, in issue 58, 2011 has proposed a decentralized and cooperative voltage control frame for a microgrid, which can suppress voltage and frequency fluctuation of the microgrid in an isolated island mode through decentralized cooperation of the DG. However, this method is limited to the isolated island mode and has a small scope of application. “Clustering and cooperative control of distributed generators for maintaining microgrid unified voltage profile and complex power control” in “Transmission and distribution conference and exposition” in 2012 has proposed a distributed optimization method of group cooperation, which achieves the optimal scheduling of DG power output in the microgrid by adjusting the voltage of control nodes with reactive power output. However, this method needs to pass a consistency variable and a change rate at the same time, which does not meet the requirements of a consistency protocol. “Layered and regional voltage regulation strategy of a distribution network based on HEM sensitivity” in “Power Construction” in issue 43 of 2022 has proposed a method of layered and regional voltage regulation of a distribution network with light storage involvement based on sensitivity analysis of a holomorphic embedding method. The upper and lower layers of voltage optimization models are established according to voltage sensitivity. This method can fully explore the adjustment ability of each adjustable resource and improve the voltage supporting ability. However, the proposed clustering partitioning method with reactive matching degree and node coupling degree as indexes has a certain contingency when the number of samples is small. “Research on optimal control method of distribution network voltage and power based on distributed cooperation” in Proceedings of the CSEE in issue 40 of 2020 designs a multi-objective distributed optimal control strategy of a distribution network in a DG grouping mode, and designs a distributed control algorithm with two groups of voltage control and power control with a capacity utilization ratio and a power factor as consistency variables. The algorithm can still quickly and accurately realize voltage control of multiple important nodes in case of photovoltaic and load change, and has strong robustness. However, the power factor of the photovoltaic inverter in this control strategy is low, and there is more active power reduction.

Therefore, an urgent problem for those skilled in the art is the voltage overlimit problem caused by the distribution network with high-proportion photovoltaic access.

### SUMMARY

In view of this, the present invention provides a method for group coordinated voltage control of photovoltaic inverters in a low-voltage distribution network, which effectively inhibits the voltage overlimit in the distribution network, increases the maximum photovoltaic access amount of the distribution network and has strong robustness in case of the photovoltaic and load fluctuation.

In order to achieve the above purpose, the present invention adopts the following technical solution:

A method for group coordinated voltage control of photovoltaic inverters in a low-voltage distribution network comprises the following steps:
step 1: dividing all photovoltaic inverters in a distribution network into a first voltage control group and a second voltage control group;
step 2: collecting voltages of the photovoltaic inverters corresponding to nodes in each voltage control group respectively, calculating voltage increments of access nodes, and collecting an active output of the distribution network;
step 3: synchronously judging whether the voltage increment of a first access node in the first voltage control group and the voltage increment of a second access node in the second voltage control group exceed a limit according to a set threshold range;
if the voltage increment of the first access node exceeds the limit, starting the first voltage control group to use a consistency algorithm for reactive voltage control, and calculating a reactive capacity according to the active output; and if the voltage increment cannot be inhibited from exceeding the limit when the reactive capacity in the first voltage control group is exhausted, entering step 5; otherwise, returning to step 2;
if the voltage increment of the second access node exceeds the limit, starting the second voltage control group to use the consistency algorithm for reactive voltage control; and if the voltage increment cannot be inhibited from exceeding the limit when the reactive capacity in the second control group is exhausted, entering step 4; otherwise, returning to step 2;
step 4: taking actions by the second voltage control group; conducting active reduction by the photovoltaic inverters in the group through the consistency algorithm; ending the control; otherwise, returning to step 2;

step 5: sending a reactive compensation instruction to the second voltage control group by the first voltage control group to start the second voltage control group to participate in reactive voltage control by using the consistency algorithm; if the overlimit cannot be inhibited when the reactive capacity of the second control group is exhausted, taking actions by the first voltage control group; conducting active reduction by the photovoltaic inverters in the group through the consistency algorithm; ending the control; otherwise, returning to step 2.

The technical effects of the above technical solution are that: in step 3, the reactive capacity of the photovoltaic inverters is used to regulate the voltage. If the voltage exceeds the limit, the voltage is inhibited from exceeding the limit through the reactive power of the inverters. However, if the voltage overlimit degree is large, even if the full reactive capacity of the inverter is used, the voltage overlimit cannot be completely eliminated. That is, when the reactive capacity of the first voltage control group is exhausted, the first voltage control group sends the reactive compensation instruction to the second voltage control group to start the second voltage control group to participate in reactive voltage control. If the capacity is not exhausted, the inverters of the group are continuously used for voltage control. Because reactive voltage control does not need to reduce the photovoltaic power output, it is preferably used. If the voltage still exceeds the limit when the reactive power is insufficient, the active power output must be reduced to inhibit the voltage from exceeding the limit.

Preferably, the voltage increments of the access nodes are calculated according to a DistFlow power flow algorithm, specifically:
step 21: if an output power of the photovoltaic inverter (PV) located on node I or any node i downstream of the node I is changed, comprising an active change ΔP and a reactive change ΔQ, then expressing a voltage change ΔU₁ of an access node I as:

$$Δ {U}_{I} = \frac{Δ P {\sum }_{n = 1}^{I} {R}_{n} + Δ Q {\sum }_{n = 1}^{I} {X}_{n}}{{V}_{0}}$$

if the output power of the PV located on any node i upstream of the access node I is changed, expressing the voltage change ΔU₁ of the access node I as:

$$Δ {U}_{I} = \frac{Δ P {\sum }_{n = 1}^{i} {R}_{n} + Δ Q {\sum }_{n = 1}^{i} {X}_{n}}{{V}_{0}}$$

wherein I represents a serial number of the access node; Rₙ+jXₙ is a line impedance from node n=1 to node n, n=1, . . . , I, i.e., the line impedance of all nodes before the access node; and V₀ represents a voltage of an initial node of a line;
thus, the voltage change at any node is simplified as:

$$Δ U = {S}_{ij} [ \begin{matrix}Δ P \\ Δ Q\end{matrix} ] \\ {S}_{ij} = \{ \begin{matrix}[ \begin{matrix}\frac{1}{{V}_{0}} {\sum }_{n = 1}^{i} {R}_{n} & \frac{1}{{V}_{0}} {\sum }_{n = 1}^{i} {X}_{n} ] , i \leq j\end{matrix} \\ [ \begin{matrix}\frac{1}{{V}_{0}} {\sum }_{n = 1}^{j} {R}_{n} & \frac{1}{{V}_{0}} {\sum }_{n = 1}^{j} {X}_{n} ] , i > j\end{matrix}\end{matrix}$$

wherein Sᵢⱼ is a sensitivity of the voltage of the node i to the power change of node j in a voltage sensitivity matrix;
step 22: obtaining a voltage increment of the access node according to the voltage variation of each node, expressed as:

$$\begin{matrix}Δ {U}^{′} = \frac{{N}_{1} {P}_{PV} {\sum }_{k = 1}^{I} {R}_{k} - {N}_{1} {Q}_{PV} {\sum }_{k = 1}^{I} {X}_{k}}{{V}_{0}} + \frac{{N}_{2} {P}_{PV} {\sum }_{k = 1}^{{N}_{1}} {R}_{k} - {N}_{2} {Q}_{PV} {\sum }_{k = 1}^{{N}_{1}} {X}_{k}}{{V}_{0}} \\ = {N}_{1} ( I + {N}_{2} ) \frac{{P}_{PV} R - {Q}_{PV} X}{{V}_{0}}\end{matrix}$$

wherein P_{PV} represents an active output power of the photovoltaic inverter of the access node; Rₖ+jXₖ represents a line impedance from node k−1 to node k; Q_{PV} represents a reactive output power of the photovoltaic inverter of the access node; N₁ represents a number of nodes in the first voltage control group; N₂ represents a number of nodes in the second voltage control group; I represents a serial number of the access node; R+jX represents a line impedance of each section of the distribution network; V₀ represents a voltage of an initial node of the line. Each node in the distribution network carries the same load, the line impedance of each section between two nodes is the same; and Pₚᵥₖ+jQₚᵥₖ=P_{PV}+Q_{PV}, Pₗₖ+jQₗₖ=P_{L}+jQ_{L}, and Rₖ+jXₖ=R+jX.

Preferably, a reactive absorption in the process of reactive voltage control is calculated; the output active power is calculated according to the active output; the reactive capacity is calculated according to the output active power; and if the reactive absorption is greater than the reactive capacity, then the reactive capacity is exhausted at this time, and the overlimit cannot be inhibited.

Preferably, the set threshold range is from 0.95 pu to 1.05 pu; and if a set threshold is exceeded, overlimit is considered.

Preferably, the reactive capacity is expressed as:

Qₘₐₓ=±\sqrt{S²−P²}
wherein S represents the capacity of the photovoltaic inverter, which is a

determined value known according to performance parameters of the photovoltaic inverter; and P represents the output active power.

Preferably, when each group of the voltage control groups is controlled by the consistency algorithm to make control actions, a capacity utilization ratio of the photovoltaic inverter corresponding to each access node is the same; and the consistency algorithm is expressed as:

$${\partial }_{GVi , j} ( k + 1 ) = {\sum }_{m = 1}^{{N}_{i}} {β}_{GVi , jm} {\partial }_{GVi , m} ( k ) + λ {\sum }_{m = 1}^{{N}_{i}} {a}_{im} ( {\partial }_{GVi , m} ( k ) - {\partial }_{GVi , j} ( k ) ) \\ {β}_{GVi , jm} = {l}_{jm} / {\sum }_{m = 1}^{{N}_{i}} {l}_{jm}$$

wherein a ∂_{GVi,j} (k+1) is the capacity utilization ratio or power factor obtained after k+1 iteration of the photovoltaic inverter of the node j in the voltage control group i, and the capacity utilization ratio is consistent with the power factor; Nᵢ is a number of the photovoltaic inverters in the voltage control group i; λ is an iteration step size, and a value range is 0-1; the larger the iteration step size is, the faster a convergence speed is, but the lower the accuracy is; αᵢₘ is an element in an adjacency matrix A; the adjacency matrix A is constructed according to a topology of network connection; if there is a connection between the node i and node m, the element is 1;

$${\sum }_{m = 1}^{{N}_{1}} {β}_{GVi , jm} {\partial }_{GVi , m} ( k )$$

is a comprehensive influence on the photovoltaic inverter of the node j by other nodes in the voltage control group; β_{GVi,jm} is a weight of the power factor or the capacity utilization ratio a ∂_{GVi,m} (k) of the PV of node m in the same group in all information received by the PV of node j in the voltage control group; if 1ⱼₘ=1(j≠m), it represents that there is a bidirectional communication line between the PV of the node j and the PV of the node m; and if 1ⱼₘ=0, it represents that there is no communication line between the PV of the node j and the PV of the node m.

Preferably, when the voltage increment of the first access node of the first voltage control group exceeds the limit, reactive voltage control is carried out only by the first voltage control group, or when the second voltage control group participates in reactive voltage control, the reactive absorption Q_{GV1} is expressed as:

$${Q}_{GV 1} = \frac{Δ {U}_{1}^{′} {V}_{0}}{{I}_{1} X}$$

wherein ΔU′₁ represents the voltage increment of the access node of the first voltage control group; V₀ represents a voltage of the initial node of the line; I₁ represents a serial number of the access node of the first voltage control group; the line impedance of each section between the nodes in the distribution network is the same, and R+jX represents the line impedance of each section in the distribution network; because the power changes of the first voltage control group and the second voltage control group have the same influence on the voltage of the access node, calculation formulas for the reactive absorption are the same; and when the second voltage control group participates in reactive voltage control, the second voltage control group still controls the voltage of the first access node, so the node voltage increment still belongs to the first access node, but the power change at this time belongs to the second voltage control group.

When the voltage increment of the second access node of the second voltage control group exceeds the limit and the second voltage control group performs reactive voltage control, the reactive absorption Q_{GV}2 of the second voltage control group is expressed as:

$${Q}_{GV 2} = \frac{Δ {U}_{2}^{′} {V}_{0}}{{I}_{2} X}$$

wherein ΔU′₂ represents the voltage change of the access node of the second voltage control group; V₀ represents the voltage of the initial node of the line; I₂ represents a serial number of the access node of the second voltage control group; R+jX represents the line impedance of each section in the distribution network; the active output power of the photovoltaic inverter of each node in the distribution network is the same as the reactive output power of the photovoltaic inverter; each node carries the same load; the line impedance of each section between two nodes is the same; Pₚᵥₖ+jQₚᵥₖ=P_{PV}+Q_{PV}, Pₗₖ+jQₗₖ=P_{L}+jQ_{L}, and Rₖ+jXₖ=R+jX.

Preferably, when the photovoltaic inverter in the first voltage control group adopts the consistency algorithm for active reduction, the active reduction P_{GV1} of the first voltage control group is expressed as:

$${P}_{GV 1} = \frac{Δ {U}_{1}^{′} {V}_{0}}{{I}_{1} R}$$

wherein ΔU′₁ represents the voltage increment of the access node of the first

voltage control group; V₀ represents the voltage of the initial node of the line; I₁ represents a serial number of the access node of the first voltage control group; the line impedance of each section between the nodes in the distribution network is the same; and R+jX represents the line impedance of each section in the distribution network;
when the photovoltaic inverter in the second voltage control group adopts the consistency algorithm for active reduction, the active reduction P_{GV2} of the second voltage control group is expressed as:

$${P}_{GV 2} = \frac{Δ {U}_{2}^{′} {V}_{0}}{{I}_{2} R}$$

wherein ΔU′₂ represents the voltage increment of the access node of the second voltage control group; V₀ represents the voltage of the initial node of the line; I₂ represents a serial number of the access node of the second voltage control group; the line impedance of each section between the nodes in the distribution network is the same; R+jX represents the line impedance of each section in the distribution network; the active output power of the photovoltaic inverter of each node in the distribution network is the same as the reactive output power of the photovoltaic inverter; each node carries the same load; the line impedance of each section between two nodes is the same; Pₚᵥₖ+jQₚᵥₖ=P_{PV}+Q_{PV}, Pₗₖ+jQₗₖ=P_{L}+jQ_{L}, and Rₖ+jXₖ=R+jX.

Preferably, the reactive compensation instruction is transmitted through a communication line between the first voltage control group and the second voltage control group. The reactive compensation instruction is transmitted through the communication line between the groups, and after the reactive compensation instruction is transmitted to the second voltage control group, the second voltage control group adjusts the reactive change for voltage control.

According to the above technical solution, compared with the prior art, the present invention discloses and provides a method for group coordinated voltage control of photovoltaic inverters in a low-voltage distribution network, which proposes the idea of group coordinated control of the photovoltaic inverters according to the differences of voltage stability factor (VSF) of different nodes for the problem of voltage overlimit caused by massive photovoltaic grid connection, and adjusts the sequence of the groups for participating in voltage control according to the VSF of each group. The photovoltaic inverters in each group use the capacity utilization ratio and the power factor as consistency variables for voltage control, and use the coordinate control strategies between the groups to ensure that the voltage of key nodes converges to a set value. When the voltage overlimit occurs, the group with high voltage stability factor is preferably used to participate in voltage control. After the group cannot inhibit the voltage overlimit, a voltage control instruction is transmitted to other groups. This control strategy can effectively inhibit the voltage overlimit, avoid unnecessary active reduction, and has strong robustness during load and photovoltaic fluctuation.

### DESCRIPTION OF DRAWINGS

To more clearly describe the technical solutions in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a flow chart of a group coordinated voltage control strategy provided by the present invention;

FIG. 2 is a structural schematic diagram of a feeder network of a simplified low-voltage distribution network provided by the present invention;

FIG. 3 is a schematic diagram of a traditional distributed photovoltaic access distribution network provided by the present invention;

FIG. 4 is a schematic diagram of photovoltaic groups of a distribution network provided by the present invention;

FIG. 5 is a schematic diagram of access voltage distribution by a traditional

distributed mode and a group mode without control provided by the present invention;

FIG. 6 is a schematic diagram of voltage distribution of each node at maximum photovoltaic access amounts provided by the present invention;

FIG. 7 is a schematic diagram of key node voltage at sudden change of loads provided by the present invention;

FIG. 8(a) is a schematic diagram of active output of each PV in GV1 at sudden change of loads provided by the present invention;

FIG. 8(b) is a schematic diagram of reactive output of each PV in GV1 at sudden change of loads provided by the present invention;

FIG. 9(a) is a schematic diagram of active output of each PV in GV2 at sudden change of loads provided by the present invention;

FIG. 9(b) is a schematic diagram of reactive output of each PV in GV2 at sudden change of loads provided by the present invention;

FIG. 10 is a schematic diagram of voltage distribution of key nodes at sudden photovoltaic change provided by the present invention;

FIG. 11(a) is a schematic diagram of active output of each PV in GV1 at sudden photovoltaic change provided by the present invention;

FIG. 11(b) is a schematic diagram of reactive output of each PV in GV1 at sudden photovoltaic change provided by the present invention;

FIG. 12(a) is a schematic diagram of active output of each PV in GV2 at sudden photovoltaic change provided by the present invention;

FIG. 12(b) is a schematic diagram of reactive output of each PV in GV2 at sudden photovoltaic change provided by the present invention.

### DETAILED DESCRIPTION

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

### EMBODIMENT 1

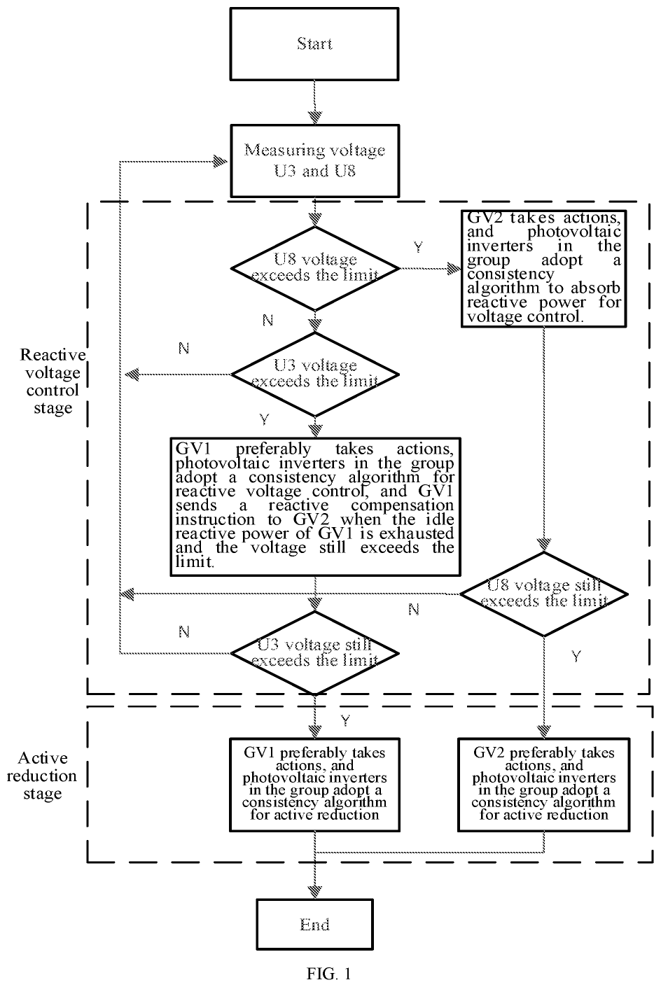

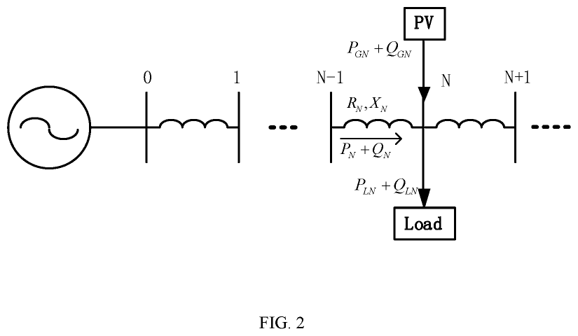

The embodiment of the present invention discloses a method for group coordinated voltage control of photovoltaic inverters in a low-voltage distribution network, and the process is shown in FIG. 1. The feeder network of the simplified distribution network is shown in FIG. 2. In the figure, P_{N}+jQ_{N} is a power flowing from node N−1 to node N; P_{LN}+jQ_{LN} represents a load carried by the node N; P_{GN}+jQ_{GN} represents a power outputted by PV at the node N; R_{N}+jX_{N} is a line impedance from node N−1 to node N; and V_{N} is a voltage of the node N.

According to a DistFlow power flow algorithm, if the output power of the photovoltaic inverter (PV) located on the node N or a node i downstream of the node N is changed, and active and reactive changes are ΔP and ΔQ, then the voltage change of the node N is:

$$Δ {U}_{N} = \frac{Δ P {\sum }_{n = 1}^{N} {R}_{n} + Δ Q {\sum }_{n = 1}^{N} {X}_{n}}{{V}_{0}} \qquad ( 1 )$$

If the output power of the PV located on a node i upstream of the node N is changed, the voltage change of the node N is:

$$Δ {U}_{N} = \frac{Δ P {\sum }_{n = 1}^{i} {R}_{n} + Δ Q {\sum }_{n = 1}^{i} {X}_{n}}{{V}_{0}} \qquad ( 2 )$$

In combination with formulas (1)-(2), the voltage change of the node N is quantified and simplified into formula (3) for calculating a relationship between the voltage change and the power change, that is, for calculating the voltage increment of the access node.

$$Δ U = {S}_{ij} [ \begin{matrix}Δ P \\ Δ Q\end{matrix} ] \qquad ( 3 )$$

In the formula: Sᵢⱼ is a voltage stability factor matrix, with a calculation formula as follows:

$${S}_{ij} = \{ \begin{matrix}[ \begin{matrix}\frac{1}{{V}_{0}} {\sum }_{n = 1}^{i} {R}_{n} & \frac{1}{{V}_{0}} {\sum }_{n = 1}^{i} {X}_{n} ] , i \leq j\end{matrix} \\ [ \begin{matrix}\frac{1}{{V}_{0}} {\sum }_{n = 1}^{j} {R}_{n} & \frac{1}{{V}_{0}} {\sum }_{n = 1}^{j} {X}_{n} ] , i > j\end{matrix}\end{matrix} \qquad ( 4 )$$

It can be seen from the above formula (4) that the node voltage of the distribution network is more sensitive to the power changes of the node itself or downstream nodes, and the sensitivity is only related to line impedance. Therefore, according to the sensitivity, an idea of controlling different node voltages for different voltage control groups is proposed.

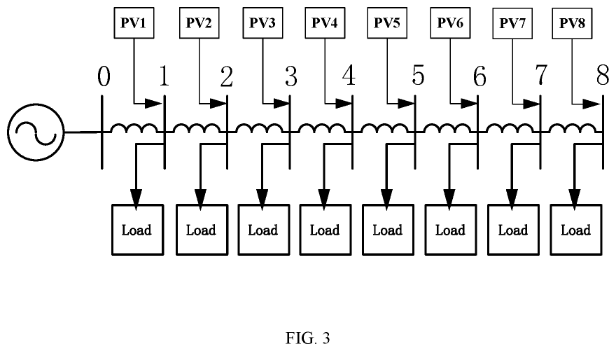

The node voltage changes in the same photovoltaic access of the traditional distributed control strategy and the group coordinated voltage control of the present invention are compared. The schematic diagram of the traditional distributed photovoltaic access distribution network is shown in FIG. 3, comprising 8 groups of photovoltaic inverters corresponding to 8 nodes. Taking the voltage increment of node 8 as an example, the voltage increment of node 8 during photovoltaic access is:

$$Δ {U}_{8} = \frac{{P}_{pv 1} {\sum }_{k = 1}^{1} {R}_{k} - {Q}_{pv 1} {\sum }_{k = 1}^{1} {X}_{k}}{{V}_{0}} + \frac{{P}_{pv 2} {\sum }_{k = 1}^{2} {R}_{k} - {Q}_{pv 2} {\sum }_{k = 1}^{2} {X}_{k}}{{V}_{0}} … + \frac{{P}_{pv 8} {\sum }_{k = 1}^{8} {R}_{k} - {Q}_{pv 8} {\sum }_{k = 1}^{8} {X}_{k}}{{V}_{0}} = 36 \frac{{P}_{PV} R - {Q}_{PV} X}{{V}_{0}} \qquad ( 5 )$$

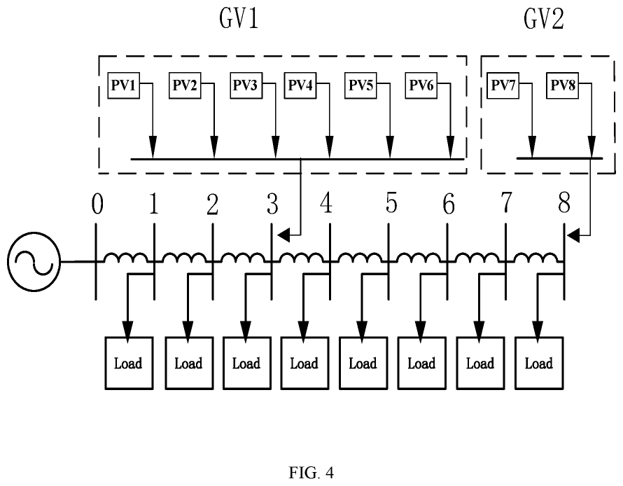

The schematic diagram of photovoltaic grouping of the distribution network in the group coordinated voltage control method of the present invention is shown in FIG. 4, comprising 8 groups of photovoltaic inverters corresponding to 8 nodes. Nodes 1-6 are divided into a first voltage control group, and the accessed PVs comprise PV₁, PV₂ . . . PV₆; nodes 7-8 are divided into a second voltage control group, and the accessed PVs comprise PV7 and PV8, wherein node 3 and node 8 serve as access nodes, and the voltage increment of the node 8 during photovoltaic access is:

$$\begin{matrix}Δ {U}_{8}^{′} = \frac{6 {P}_{PV} {\sum }_{k = 1}^{3} {R}_{k} - 6 {Q}_{PV} {\sum }_{k = 1}^{3} {X}_{k}}{{V}_{0}} + \frac{2 {P}_{PV} {\sum }_{k = 1}^{6} {R}_{k} - 2 {Q}_{PV} {\sum }_{k = 1}^{6} {X}_{k}}{{V}_{0}} \\ = 30 \frac{{P}_{PV} R - {Q}_{PV} X}{{V}_{0}}\end{matrix} \qquad ( 6 )$$

It can be seen from formulas (5)-(6) that when the photovoltaic inverters output the same active power, the voltage change in the grouping mode is reduced by 5/6 compared with the traditional distribution. Therefore, the grouping mode of the present invention can better suppress the voltage overlimit problem when dealing with the distribution network with high-proportion of photovoltaic access.

In order to better use the limited reactive capacity of PV to control the node voltage, unnecessary active reduction is avoided and the reactive flow in the system is reduced. Under the same voltage change, the reactive changes of the photovoltaic inverters in different groups are compared, which is convenient to arrange the order of the groups to participate in voltage regulation when the voltage exceeds the limit.

1) In a reactive voltage control stage, when the voltage increment ΔU′₃ of node 3 is the same, a reactive absorption and an active reduction are derived from formula (3). The reactive absorptions in separate actions of the first voltage control group GV1 and the second voltage control group GV2 are compared, and a set of action schemes with less active reduction or reactive absorption are preferably selected. This set has better economy.

When the GV1 performs reactive voltage control by separate actions, the reactive absorption is:

$${Q}_{GV 1} = \frac{Δ {U}_{3} {V}_{0}}{3 X} \qquad ( 7 )$$

When the GV2 performs reactive voltage control by separate actions, the reactive absorption is:

$${Q}_{GV 2} = \frac{Δ {U}_{3} {V}_{0}}{3 X} \qquad ( 8 )$$

Similarly, for voltage overlimit of the node 8, when the voltage increment ΔU′₈ of the node 8 is the same, the reactive absorptions in separate actions of the GV1 and the GV2 are compared, and when the GV1 performs reactive voltage control by separate actions, the reactive absorption is:

$${Q}_{GV 1}^{′} = \frac{Δ {U}_{8} {V}_{0}}{3 X} \qquad ( 9 )$$

When the GV2 performs reactive voltage control by separate actions, the reactive absorption is:

$${Q}_{GV 2}^{′} = \frac{Δ {U}_{8} {V}_{0}}{8 X} \qquad ( 10 )$$

2) In an active reduction voltage control stage, when the voltage increment ΔU′₃ of node 3 is the same, the active reductions in separate actions of the GV1 and the GV2 are compared. When the GV1 performs active reduction by separate actions, the active reduction is:

$${P}_{GV 1} = \frac{Δ {U}_{3}^{′} {V}_{0}}{3 R} \qquad ( 11 )$$

When the GV2 performs active reduction by separate actions, the active reduction is:

$${P}_{GV 2} = \frac{Δ {U}_{3}^{′} {V}_{0}}{3 R} \qquad ( 12 )$$

Similarly, for voltage overlimit of the node 8, when the voltage increment ΔU′₈ of the node 8 is the same, the active reductions in separate actions of the GV1 and the GV2 are compared.

When the GV1 performs active reduction by separate actions, the active reduction is:

$${P}_{GV 1}^{′} = \frac{Δ {U}_{8}^{′} {V}_{0}}{3 R} \qquad ( 13 )$$

When the GV2 performs active reduction by separate actions, the active reduction is:

$${P}_{GV 2}^{′} = \frac{Δ {U}_{8}^{′} {V}_{0}}{8 R} \qquad ( 14 )$$

It can be seen from formulas (7)-(8) that for U₃ overlimit, if the GV1 and the GV2 are used separately for reactive voltage control, the reactive absorptions of the PVs in two node groups are the same, but the GV1 has 6 PVs and the reactive absorption of each PV is Q_{GP}/6. The GV2 has two PVs, and the reactive absorption of each PV is Q_{GV}/2. If the voltage U₃ is controlled by the GV2, the reactive margin of PV in the GV2 group may be insufficient. Therefore, when the node 3 in the first voltage control group exceeds the limit, the first voltage control group firstly performs reactive voltage control and overlimit suppression. It can be seen from formulas (9)-(10) that for U₈ overlimit, the GV1 and the GV2 are used separately for reactive voltage control. When the GV2 is operated separately at the same voltage reduction, the absorbed reactive power is less, which can reduce the reactive flow in the system. Therefore, when the node 8 in the second voltage control group exceeds the limit, the second voltage control group firstly performs reactive voltage control and overlimit suppression.

It can be seen from formulas (11)-(12) that for U₃ overlimit, if the GV1 and the GV2 are used separately for active reduction voltage control, the active reductions of the PVs in two groups are the same, but the GV1 has 6 PVs, and the active reduction of each PV is P_{GP}/6; the GV2 has two PVs, and the active reduction of each PV is P_{GV}/2. This may cause that the active output of the PV in the GV2 group is too low. Therefore, when the node 3 in the first voltage control group exceeds the limit, if the reactive voltage control cannot achieve effective overlimit suppression, the first voltage control group performs active reduction control and overlimit suppression. It can be seen from formulas (13)-(14) that for U₈ overlimit, the GV1 and the GV2 are used separately for active reduction voltage control. When the GV2 is operated separately, the active reduction is smaller, and unnecessary active reduction can be avoided. Therefore, when the node 8 in the second voltage control group exceeds the limit, if the reactive voltage control cannot achieve effective overlimit suppression, the second voltage control group performs active reduction control and overlimit suppression.

In conclusion, a flow chart of the group coordinated voltage control strategy is shown in FIG. 1.

The photovoltaic inverters in the groups use the capacity utilization ratio and the power factor as consistency variables for voltage control, and an iterative formula of the consistency algorithm is:

$${\partial }_{GVi , j} ( k + 1 ) = {\sum }_{m = 1}^{{N}_{i}} {β}_{GVi , jm} {\partial }_{GVi , m} ( k ) + λ {\sum }_{m = 1}^{{N}_{i}} {a}_{im} ( {\partial }_{GVi , m} ( k ) - {\partial }_{GVi , j} ( k ) ) \qquad ( 15 )$$

In the formula, ∂_{GVi,j} (k+1) is the capacity utilization ratio/power factor obtained after k+1 iteration of the PV j in the voltage control group i, and the capacity utilization ratio is consistent with the power factor; Ni is a number of the PVs in the group; a value range of an iteration step size λ is 0-1; the larger the iteration step size is, the faster a convergence speed is, but the lower the accuracy is. αᵢₘ is an element in an adjacency matrix A;

$${\sum }_{m = 1}^{{N}_{i}} {β}_{GVi , jm} {\partial }_{GVi , m} ( k )$$

is a comprehensive influence on the node j by other nodes in the group; β_{GVi,jm} is a weight that is set for m PV information a ∂_{GVi,m}(k) in the same group received by the PV j in the group, calculated as follows:

$${β}_{GVi , jm} = {l}_{jm} / {\sum }_{m = 1}^{{N}_{i}} {l}_{jm} \qquad ( 16 )$$

In the formula: Iⱼₘ₌₁(J≠m)—there is a bidirectional communication line between the PV j and the PV m if there is a communication link between the distributed power supplies j and m, and lᵢₘ₌0−there is no communication line therebetween.

After the capacity utilization ratio and the power factor in each group are determined, the active power and reactive power output of each PV in the group can be determined. The active power is P=S*cos φ, and the reactive power Q=Qₘₐₓ* reactive utilization ratio, wherein S is the capacity of the photovoltaic inverter, cos φ is the power factor, and Qₘₐₓ is a maximum idle capacity.

### EMBODIMENT 2

The IEEE node 8 example simulation with photovoltaic inverters is built in MATLAB software, as shown in FIG. 4. The basic parameters of the system are: unit line impedance (0.602+j0.232) Ω/km, node spacing 0.06 km, inverter capacity 15 kVA, safe voltage range 0.95 pu-1.05 pu, and rated voltage 380V. Since the geographical location, temperature, light and load conditions of each photovoltaic inverter are very close, it is assumed that each load condition, photovoltaic inverter capacity and photovoltaic output are consistent. The access node that contains photovoltaic inverters 1-6 in the voltage control group GV1 is node 3; and the access node that contains photovoltaic inverters 7 and 8 in the voltage control group GV2 is node 8. The capacity utilization ratio and the power factor are used as the consistency variables in the groups, and coordinated control is adopted between the groups. The node voltage distribution in the traditional distributed mode and the group

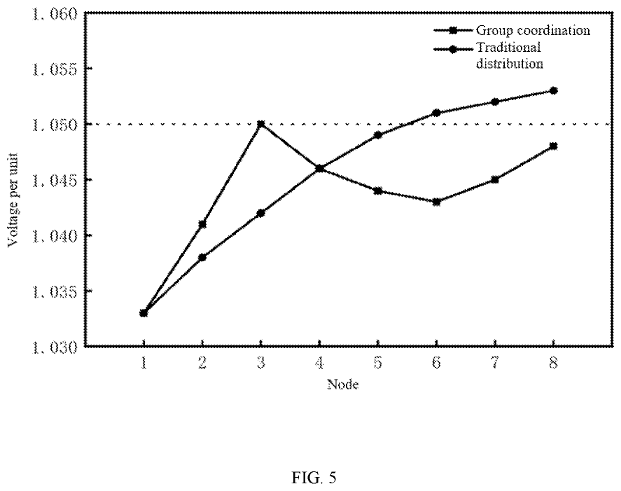

mode is verified when the photovoltaic output is 11.5 Kw and the load is 7.5 kW without control, as shown in FIG. 5.

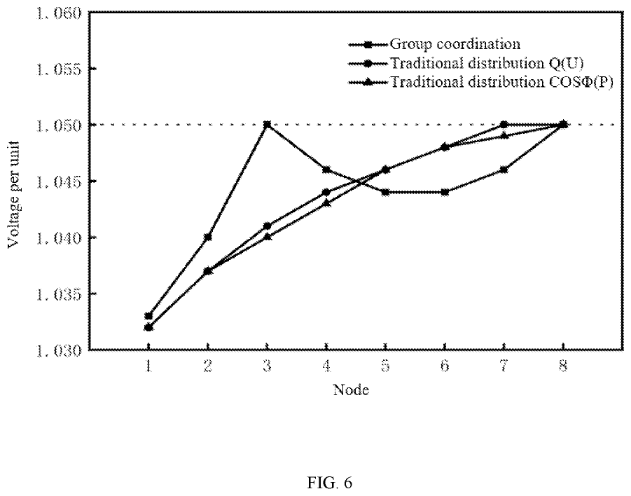

The traditional distributed Q(U) control strategy, the traditional distributed COSφ(P) control strategy and the group coordinated control strategy of the present invention are adopted respectively in the distribution network. On the premise of ensuring that the voltage does not exceed the limit, a trial method is used to compare the maximum photovoltaic access amounts of the three control strategies. The voltage distribution of each node at the maximum photovoltaic access amounts is shown in FIG. 6. The maximum photovoltaic access amounts of the three control strategies are 109.6 Kw, 103.2 kW and 111.2 kW. This indicates that the group coordinated control can also improve the absorption capacity of the low-voltage distribution network on the photovoltaic on the premise of ensuring that the voltage of key nodes converges to a set value.

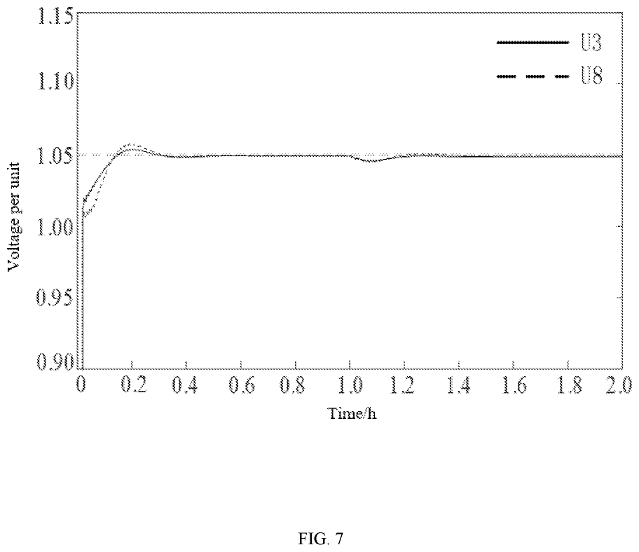

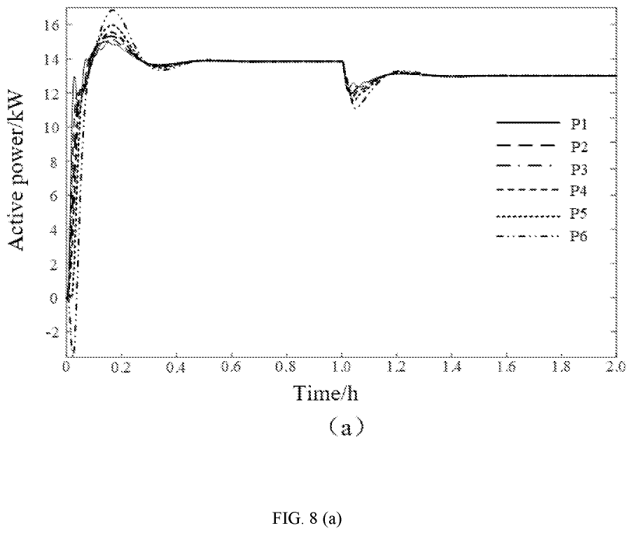

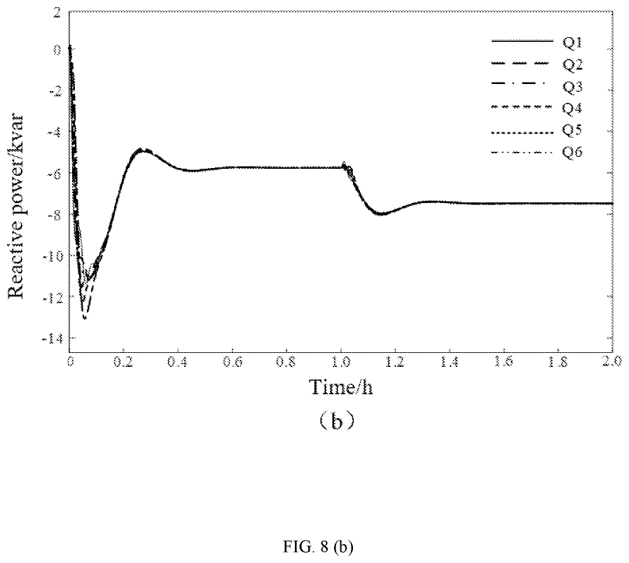

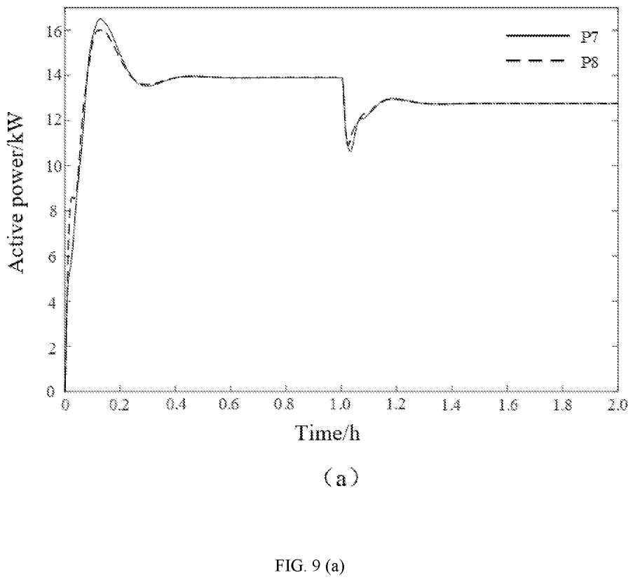

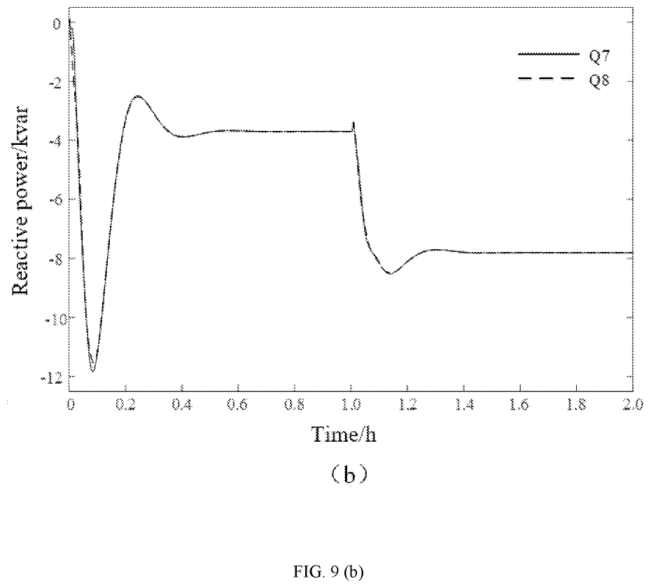

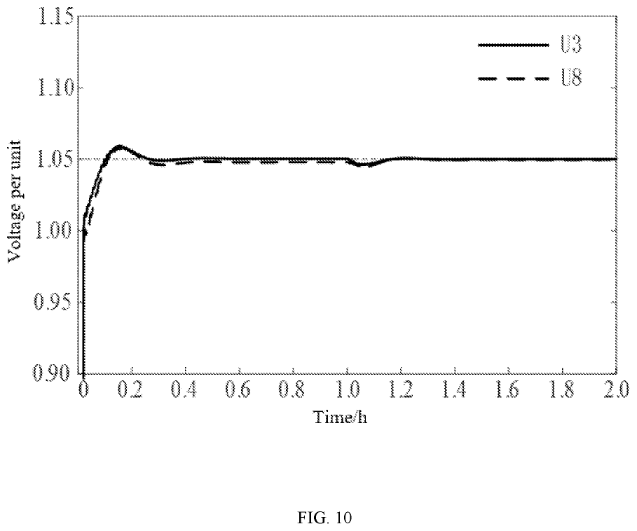

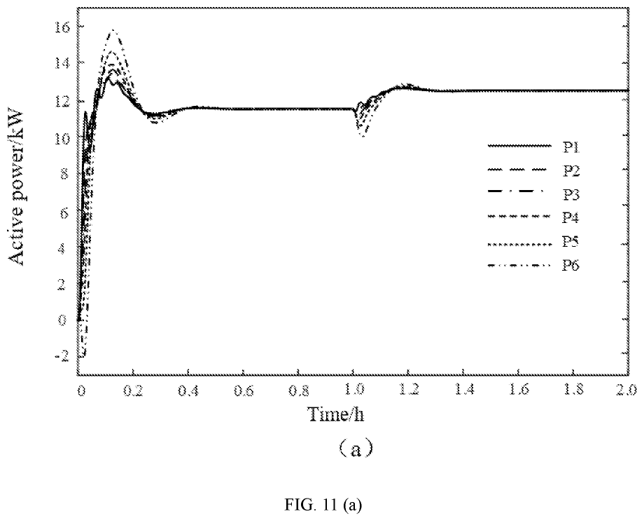

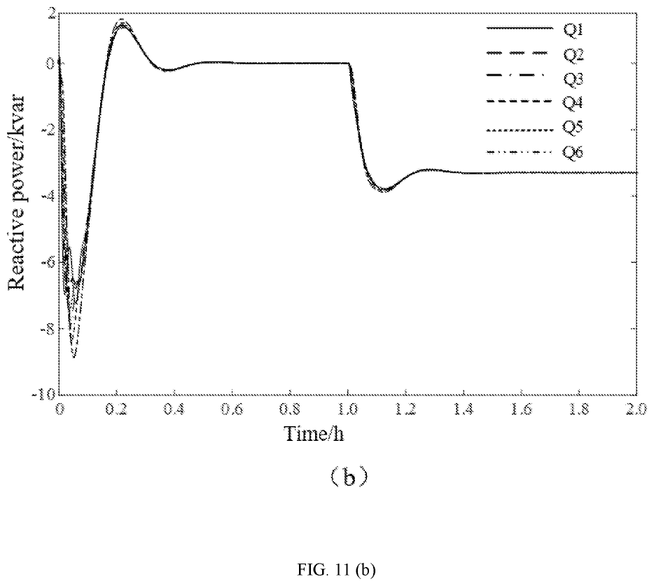

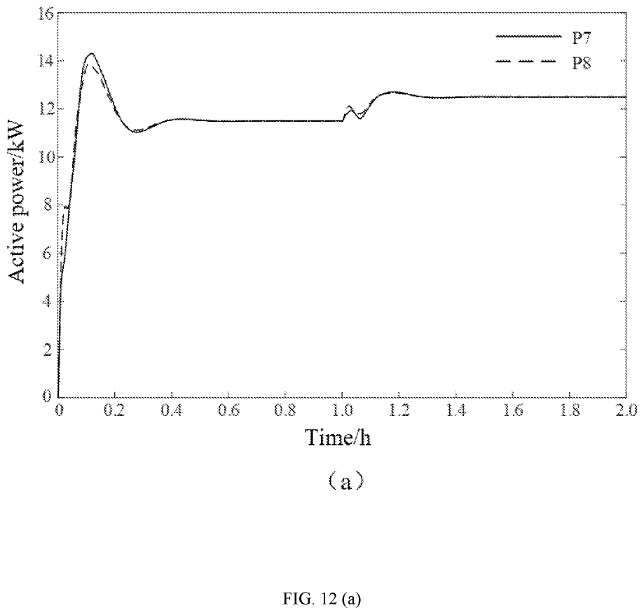

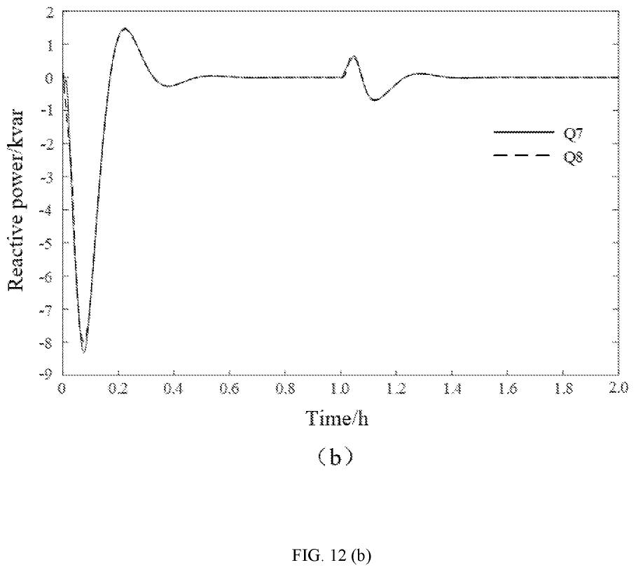

In order to further verify that the present invention has strong robustness at load and photovoltaic fluctuation, based on the maximum photovoltaic access amounts, the load is reduced from 7.5 kW to 5.5 kW at 1 h. After the group coordinated control, the voltage changes of the key nodes are shown in FIG. 7, and the active and reactive outputs of each PV in the GV1 and the GV2 are shown in FIGS. 8-9. In addition, on the basis of the load of 7.5 kW, the output power of the photovoltaic inverter increases sharply at 1 h, from 11.5 kW to 12.5 kW, to simulate the fluctuation of photovoltaic output. After the group coordinated control strategy, the voltage of the key nodes is shown in FIG. 10, and the active and reactive outputs of each PV in the GV1 and the GV2 are shown in FIGS. 11 and 12.

The simulation example results indicate that: compared with the traditional distributed Q(U) control and the traditional distributed control, the control strategy proposed by the present invention can improve the maximum photovoltaic access amounts of the system, wherein the maximum photovoltaic access amounts are increased by 1.46% and 7.75%, respectively. In addition, the proposed control strategy preferably uses the group with high voltage stability factor to participate in voltage control, which can reduce the active reduction and the reactive absorption of the photovoltaic inverters, thereby improving the economy of the system. During load and photovoltaic fluctuation, the control strategy proposed by the present invention can still accurately control the voltage convergence of the key nodes to the set value, which indicates that the strategy has strong robustness. Based on the group control method of the present invention, the distribution network is divided into two or several groups of voltage control groups. By judging whether the voltage increment of the access node exceeds the limit, the consistency algorithm is adopted to combine several groups of voltage controllers to control reactive voltage or active reduction, so as to suppress the voltage overlimit.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. A method for group coordinated voltage control of photovoltaic inverters in a low-voltage distribution network, comprising the following steps:
step 1: dividing all photovoltaic inverters in a distribution network into a first voltage control group and a second voltage control group;
step 2: collecting voltages of the photovoltaic inverters corresponding to nodes in each voltage control group respectively, calculating voltage increments of access nodes, and collecting an active output of the distribution network;
step 3: synchronously judging whether the voltage increment of a first access node in the first voltage control group and the voltage increment of a second access node in the second voltage control group exceed a limit according to a set threshold range;
if the voltage increment of the first access node exceeds the limit, starting the first voltage control group to use a consistency algorithm for reactive voltage control, and calculating a reactive capacity according to the active output; and if the voltage increment cannot be inhibited from exceeding the limit when the reactive capacity in the first voltage control group is exhausted, entering step 5; otherwise, returning to step 2;
if the voltage increment of the second access node exceeds the limit, starting the second voltage control group to use the consistency algorithm for reactive voltage control; and if the voltage increment cannot be inhibited from exceeding the limit when the reactive capacity in the second control group is exhausted, entering step 4; otherwise, returning to step 2;
step 4: taking actions by the second voltage control group; conducting active reduction by the photovoltaic inverters in the group through the consistency algorithm; ending the control; otherwise, returning to step 2;
step 5: sending a reactive compensation instruction to the second voltage control group by the first voltage control group to start the second voltage control group to participate in reactive voltage control by using the consistency algorithm; if the overlimit cannot be inhibited when the reactive capacity of the second control group is exhausted, taking actions by the first voltage control group; conducting active reduction by the photovoltaic inverters in the group through the consistency algorithm; ending the control; otherwise, returning to step 2.

2. The method for group coordinated voltage control of photovoltaic inverters in the low-voltage distribution network according to claim 1, wherein in step 2, the voltage increments of the access nodes are calculated according to a DistFlow power flow algorithm, specifically:
step 21: if an output power of the photovoltaic inverter located on access node I or any node i downstream of the node I is changed, and the changes comprise an active change ΔP and a reactive change ΔQ, then expressing a voltage change ΔU₁ of the access node I as:
$$Δ {U}_{I} = \frac{Δ P {\sum }_{n = 1}^{I} {R}_{n} + Δ Q {\sum }_{n = 1}^{I} {X}_{n}}{{V}_{0}}$$
if the output power of the photovoltaic inverter located on any node i upstream of the access node I is changed, expressing the voltage change ΔU₁ of the access node I as:
$$Δ {U}_{I} = \frac{Δ P {\sum }_{n = 1}^{i} {R}_{n} + Δ Q {\sum }_{n = 1}^{i} {X}_{n}}{{V}_{0}}$$
wherein I represents a serial number of the access node; Rₙ+jXₙ is a line impedance from node n−1 to node n, n=1, . . . I; and V₀ represents a voltage of an initial node of a line;
the voltage change at any node is simplified as:
$$Δ U = {S}_{ij} [ \begin{matrix}Δ P \\ Δ Q\end{matrix} ]$$
$${S}_{ij} = \{ \begin{matrix}[ \frac{1}{{V}_{0}} {\sum }_{n = 1}^{i} {R}_{n} & \frac{1}{{V}_{0}} {\sum }_{n = 1}^{i} {X}_{n} ] , & i \leq j \\ [ \frac{1}{{V}_{0}} {\sum }_{n = 1}^{j} {R}_{n} & \frac{1}{{V}_{0}} {\sum }_{n = 1}^{j} {X}_{n} ] , & i > j\end{matrix}$$
wherein Sᵢⱼ is a sensitivity of the voltage of the node i to the power change of node j in a voltage sensitivity matrix;
step 22: obtaining a voltage increment of the access node according to the voltage variation of each node, expressed as:
$$Δ {U}^{′} = \frac{{N}_{1} {P}_{PV} {\sum }_{k = 1}^{I} {R}_{k} - {N}_{1} {Q}_{PV} {\sum }_{k = 1}^{I} {X}_{k}}{{V}_{0}} + \frac{{N}_{2} {P}_{PV} {\sum }_{k = 1}^{{N}_{1}} {R}_{k} - {N}_{2} {Q}_{PV} {\sum }_{k = 1}^{{N}_{1}} {X}_{k}}{{V}_{0}} = {N}_{1} ( I + {N}_{2} ) \frac{{P}_{PV} R - {Q}_{PV} X}{{V}_{0}}$$
wherein P_{PV} represents an active output power of the photovoltaic inverter of the access node; Rₖ+jXₖ represents a line impedance from node k−1 to node k; Q_{PV} represents a reactive output power of the photovoltaic inverter of the access node; N₁ represents a number of nodes in the first voltage control group; N₂ represents a number of nodes in the second voltage control group; I represents a serial number of the access node; the line impedances between two nodes in the distribution network are the same, and then Rₖ+jXₖ=R+jX; and V₀ represents a voltage of an initial node of the line.

3. The method for group coordinated voltage control of photovoltaic inverters in the low-voltage distribution network according to claim 1, wherein a reactive absorption in a process of reactive voltage control is calculated; the output active power is calculated according to the active output; the reactive capacity is calculated according to the output active power; and if the reactive absorption is greater than the reactive capacity, then the reactive capacity is exhausted at this time, and the overlimit cannot be inhibited.

4. The method for group coordinated voltage control of photovoltaic inverters in the low-voltage distribution network according to claim 3, wherein the reactive capacity is expressed as:
Qₘₐₓ=±\sqrt{S²−P²}
wherein S represents the capacity of the photovoltaic inverter, and P represents the output active power.

5. The method for group coordinated voltage control of photovoltaic inverters in the low-voltage distribution network according to claim 1, wherein when each group of the voltage control groups is controlled by the consistency algorithm to make control actions, a capacity utilization ratio of the photovoltaic inverter corresponding to each access node is the same; and the consistency algorithm is expressed as:
$${\partial }_{GVi , j} ( k + 1 ) = {\sum }_{m = 1}^{{N}_{i}} {β}_{GVi , jm} {\partial }_{GVi , m} ( k ) + λ {\sum }_{m = 1}^{{N}_{i}} {a}_{im} ( {\partial }_{GVi , m} ( k ) - {\partial }_{GVi , j} ( k ) )$$
$${β}_{GVi , jm} = {l}_{jm} / {\sum }_{m = 1}^{{N}_{i}} {l}_{jm}$$
wherein ∂_{GVi,j} (k+1) is the capacity utilization ratio or power factor obtained after k+1 iteration of the photovoltaic inverter of the node j in the voltage control group i; Nᵢ is a number of the photovoltaic inverters in the voltage control group i; λ is an iteration step size; αᵢₘ is an element in an adjacency matrix A;
$${\sum }_{m = 1}^{{N}_{1}} {β}_{GVi , jm} {\partial }_{GVi , m} ( k )$$
is a comprehensive influence on the photovoltaic inverter of the node j by other nodes in the voltage control group; β_{GVi,jm} is a weight of the capacity utilization ratio or the power factor ∂_{GVi,m} (k) of the photovoltaic inverter of node m in the same group in all information received by the photovoltaic inverter of node j in the voltage control group; 1ⱼₘ=1(j≠m) represents that there is a bidirectional communication line between the photovoltaic inverter of the node j and the photovoltaic inverter of the node m; and 1ⱼₘ=0 represents that there is no communication line between the photovoltaic inverter of the node j and the photovoltaic inverter of the node m.

6. The method for group coordinated voltage control of photovoltaic inverters in the low-voltage distribution network according to claim 2, wherein when the voltage increment of the first access node of the first voltage control group exceeds the limit, reactive voltage control is carried out only by the first voltage control group, or when the second voltage control group participates in reactive voltage control, the reactive absorption Q_{GV1} is expressed as:
$${Q}_{GV 1} = \frac{Δ {U}_{1}^{′} {V}_{0}}{{I}_{1} X}$$
wherein ΔU′₁ represents the voltage increment of the access node of the first voltage control group; V₀ represents a voltage of the initial node of the line; I₁ represents a serial number of the access node of the first voltage control group; the line impedance of each section between the nodes in the distribution network is the same, and R+jX represents the line impedance of each section in the distribution network;
when the voltage increment of the second access node of the second voltage control group exceeds the limit and the second voltage control group performs reactive voltage control, the reactive absorption Q_{GV}2 is expressed as:
$${Q}_{GV 2} = \frac{Δ {U}_{2}^{′} {V}_{0}}{{I}_{2} X}$$
wherein ΔU′₂ represents the voltage change of the access node of the second voltage control group; V₀ represents the voltage of the initial node of the line; I₂ represents a serial number of the access node of the second voltage control group; the line impedance of each section between the nodes in the distribution network is the same, and R+jX represents the line impedance of each section in the distribution network.

7. The method for group coordinated voltage control of photovoltaic inverters in the low-voltage distribution network according to claim 2, wherein when the photovoltaic inverter in the first voltage control group adopts the consistency algorithm for active reduction, the active reduction P_{GV1} of the first voltage control group is expressed as:
$${P}_{GV 1} = \frac{Δ {U}_{1}^{′} {V}_{0}}{{I}_{1} R}$$
wherein ΔU′₁ represents the voltage increment of the access node of the first voltage control group; V₀ represents the voltage of the initial node of the line; I₁ represents a serial number of the access node of the first voltage control group; the line impedance of each section between the nodes in the distribution network is the same; and R+jX represents the line impedance of each section in the distribution network;
when the photovoltaic inverter in the second voltage control group adopts the consistency algorithm for active reduction, the active reduction P_{GV2} of the second voltage control group is expressed as:
$${P}_{GV 2} = \frac{Δ {U}_{2}^{′} {V}_{0}}{{I}_{2} R}$$
wherein ΔU′₂ represents the voltage increment of the access node of the second voltage control group; V₀ represents the voltage of the initial node of the line; I₂ represents a serial number of the access node of the second voltage control group; the line impedance of each section between the nodes in the distribution network is the same; and R+jX represents the line impedance of each section in the distribution network.

8. The method for group coordinated voltage control of photovoltaic inverters in the low-voltage distribution network according to claim 1, wherein the reactive compensation instruction is transmitted through a communication line between the first voltage control group and the second voltage control group.
